(19) United States
(12) Patent Application Publication
(10) Pub. No.: US 2017/0136718 A1
(43) Pub. Date: May 18, 2017

(54) Method of making a composite board and a product made thereby

(71) Applicant: Cheng-Chung CHANG, Taichung (TW)

(72) Inventor: Cheng-Chung CHANG, Taichung (TW)

(21) Appl. No.: 14/939,858

(22) Filed: Nov. 12, 2015

(51) Int. Cl. B29C 70/74; B29C 44/12; B29C 39/02

(52) U.S. Cl. CPC B29C 70/745; B29C 39/026; B29C 44/12; B29K 2075/00

(57) ABSTRACT

A method of making a composite board and a product made thereby are disclosed. The method includes a lining forming step, a fiber pipe rolling step, a fiber pipe mounting step, a fiber material covering step, and a board body forming step. The product includes a lining acting as a board body, a plurality of long slots formed on the lining, a fiber pipe placed in each of long slots, a foam material mounted in each of fiber pipes, and a fiber material covering an external periphery of the lining. The fiber materials and the fiber pipes are melted and combined together by heat, thereby shortening the operating time. The fiber pipe becomes a reinforcement support structure to increase a structural strength of the composite board, thereby producing a finished product with a light weight and a strong structure.

### BACKGROUND OF THE INVENTION

1. Field of the Invention

This invention relates to a composite board and relates particularly to a composite board applied to sports equipment.

2. Description of the Related Art

Typical composite boards applied to board equipment, such as skateboards, aquaplanes, snowboards, and surfboards, and applied to sports equipment like rackets, etc., are generally made of wood, plastic, or metal processed by machining, splicing, and lapping to produce finished products. However, due to along period of researches and productions, tests, and marketing made by the inventor skilled in the art, the inventor finds that the manufacturing process of the aforementioned composite board takes a lot of work and time and it is hard to get some raw materials such as wood of high quality. If the plastic material is adopted, the structure of finished products made of plastic lacks sufficient strength. If the metal material is adopted, the procedure of processing the metal material is difficult and a weight of finished products made thereby is heavy.

### SUMMARY OF THE INVENTION

The object of this invention is to provide a method of making a composite board and a product made thereby. The method is simple and is capable of effectively shortening operating time and producing the product with a light weight and a strong structure. To achieve aforementioned purposes, a method of making a composite board in accordance with this invention includes a lining forming step, a fiber pipe rolling step, a fiber pipe mounting step, a fiber material covering step, and a board body forming step. The lining forming step is executed by filling at least one filler in the first mold in order to solidify the filler into a lining, taking the lining out of the first mold, a plurality of long slots being formed on the lining by the first mold. The fiber pipe rolling step is executed by respectively rolling a plurality of fiber materials into a plurality of fiber pipes, placing a foam material in each of fiber pipes, adjusting a size of the fiber pipes to respectively correspond to a size of the long slots. The fiber material mounting step is executed by placing the fiber pipes into each of the long slots of the lining. The fiber material covering step is executed by covering an external periphery of the lining with a fiber material. The board body forming step is executed by locating the lining covered with the fiber material into a second mold, heating the lining in order to foam and expand the foam material inside the fiber pipes at a high temperature and open the fiber pipes, the fiber pipes pushing an inner side of the fiber material covering the lining from the long slots of the lining in order to make the fiber materials and the fiber pipes being melted and blended by the heat and solidified after cooling.

The composite board provided by this invention includes a lining acting as a board body, a plurality of long slots formed on the lining, a plurality of reinforcement ribs which acts as a pipe body containing a foam material located therein and the reinforcement ribs being set in the long slots of the lining, a covering layer being placed at an external periphery of the lining and combined with the reinforcement ribs.

The method of making the composite board and the product made thereby of this invention includes a lining forming step, a fiber pipe rolling step, a fiber pipe mounting step, a fiber material covering step, and a board body forming step. The method is executed by filling in the filler in order to form the lining, placing the fiber pipes into each of the long slots of the lining, covering the external periphery of the lining with the fiber material, melting the fiber materials and the fiber pipes as a heated substance by heating, and thence solidifying the heated substance by cooling in order to form a finished composite board. The method of this invention uses the filler whose raw material is easy to be obtained to fill the chamber so that the lining can be formed. This invention simplifies the manufacturing method and shortens the operating time in order to have an increase in the economic effectiveness. After the finished product of the composite board is solidified after heat melting, the fiber pipes in the long slots of the lining and the fiber material at the external periphery of the lining can be combined as an integrated fibrous structure. Therefore, the solidified fiber pipes can become the supporting structure of the reinforcement ribs to increase the structure strength of the composite board. Meanwhile, using the filler and the fiber material to produce the product can highly reduce the weight of the finished product to obtain a light-weight product.

### BRIEF DESCRIPTION OF THE DRAWINGS

FIG. 1 is a flow chart of this invention;

FIG. 2 is a schematic view showing the first mold of this invention;

FIG. 3 is a top plan view showing the lining of this invention;

FIG. 4 is a cross-sectional view showing the fiber pipe of this invention;

FIG. 5 is a cross-sectional view showing the fiber pipes mounted in the lining of this invention;

FIG. 6 is a schematic view showing the fiber material covering of this invention;

FIG. 7 is a schematic view showing the solid forming after being placed into the second mold of this invention;

FIG. 8 is a perspective view showing the finished product of this invention;

FIG. 9 is a cross-sectional view showing the finished product of this invention;

FIG. 10 is a top plan view showing the lining of other embodiment of this invention;

FIG. 11 is a cross-sectional view showing other side of 11 of FIG. 10; and

FIG. 12 is a cross-sectional view showing the fiber pipes mounted in the lining of other embodiment of this invention.

### DETAILED DESCRIPTION OF THE PREFERRED EMBODIMENTS

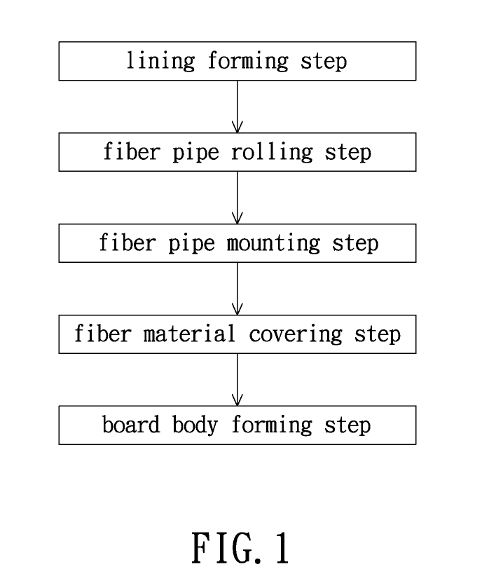

FIG. 1 showing a flow chart of this invention discloses a method of making a composite board including:

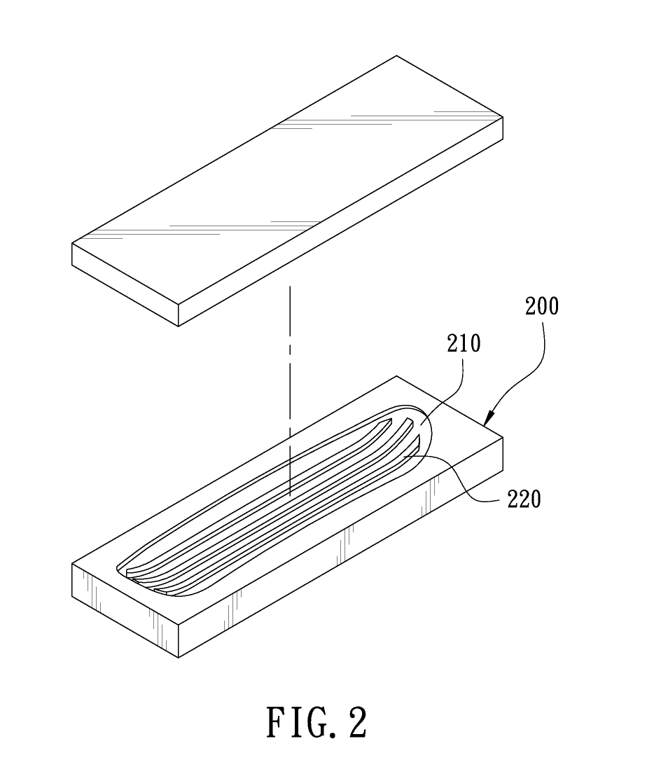

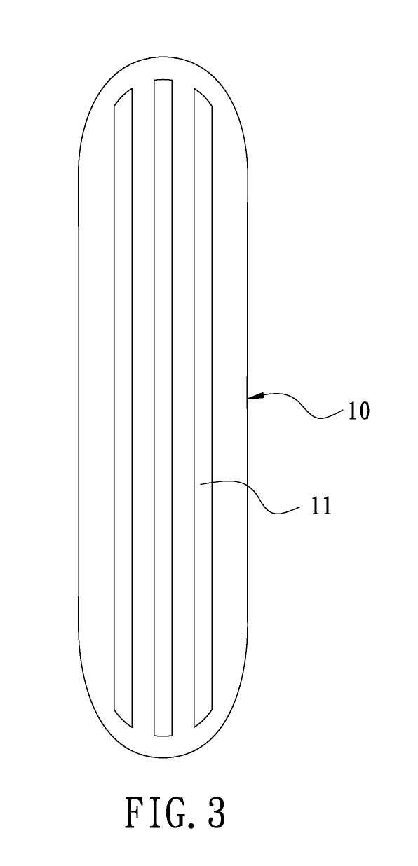

A lining forming step showed in FIG. 2 for preparing a first mold 200 which has a first chamber 210 formed therein, a plurality of ribs 220 being convexly formed on the first chamber 210, the aforementioned ribs 220 horizontally extending to the two ends of the first chamber 210, the ribs 220 being convexly formed in a parallel way with a space through a major axis of the first chamber 210 in this invention and two lateral ends of the ribs 220 having a predetermined space with an inner wall of the first chamber 210 whereby the ribs 220 are separated singly in the first chamber 210, the ribs 220 being capable of convexly setting through a minor axis of the first chamber 210, or alternately setting through the major and minor axis, filling at least one filler into the first chamber 210 of the first mold 200, the filler being a PU foam in this invention, referring to FIG. 3, the filler foaming and being solidified after being filled into the first chamber 210 and turning into the lining 10 which corresponds to the inner wall of the first chamber 210, a size of the lining 10 being slightly smaller than a size of finished composite board, taking the lining 10 out of the first chamber 210 of the first mold 200, a plurality of long slots 11 being formed and corresponded to the ribs 220 of the first chamber 210 on the lining 10, the ribs 220 extending horizontally to two ends of the first chamber 210 and being singly separated through the major axis of the first chamber 210 in the first chamber 210 in this invention, whereby the lining 10 has the long slots 11 penetrating from top to bottom, the long slots 11 being formed on the middle of the lining 10 in a parallel way through the major axis of the lining 10 and kept a predetermined space with a periphery of the lining 10.

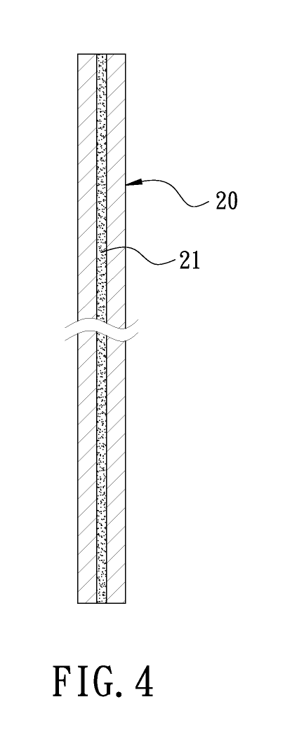

A fiber pipe rolling step showed in FIGS. 3 and FIG. 4 for respectively rolling a plurality sheet of fiber materials into a plurality of fiber pipes 20, making a size of the fiber pipes 20 to correspond to a size of the long slots 11, a length of the fiber pipes 20 respectively corresponding to a major axial length of the long slots 11, a width of the fiber pipes 20 corresponding to a major axial width of the long slots 11, a thickness of the fiber pipes 20 being slightly smaller than a depth of the long slots 11, the chosen fiber material of the fiber pipes 20 being a composite fiber, such as carbon fiber or glass fiber, which includes a light weight and a strong structure and is capable of being formed into solid by heat in this invention, placing a foam material 21 into each of the fiber pipes 20, the foam material 21 being a foam material that expands and foams by heat and turns into solid after cooling.

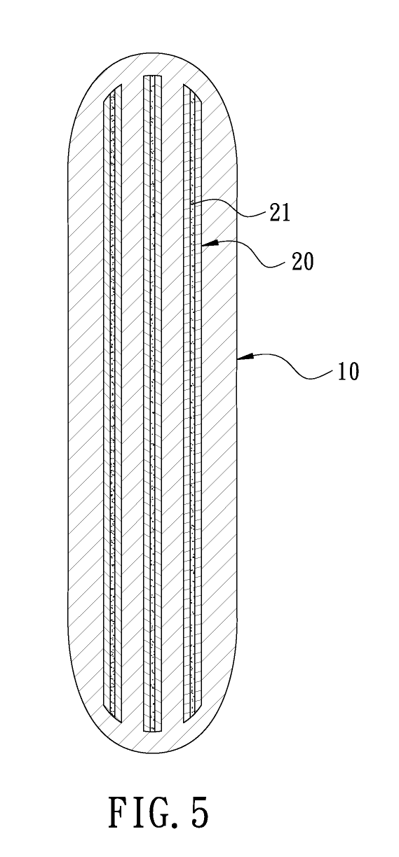

A fiber pipe mounting step showed in FIGS. 5 for placing the fiber pipes 20 separately into the long slots 11 of the lining 10, the length of the fiber pipes 20 corresponding to the major axial length of the long slots 11, the width of the fiber pipes 20 corresponding to the major axial width of the long slots 11, whereby the fiber pipes 20 can be completely placed and locked into the long slots 11 of the lining 10 and the thickness of the fiber pipes 20 is slightly smaller than the depth of the long slots 11, whereby top and end sides of the external pipe wall of the fiber pipes 20 have a predetermined space with top and end surfaces of the lining 10 in order to completely embed the fiber pipes 20 in the long slots 11 of the lining 10.

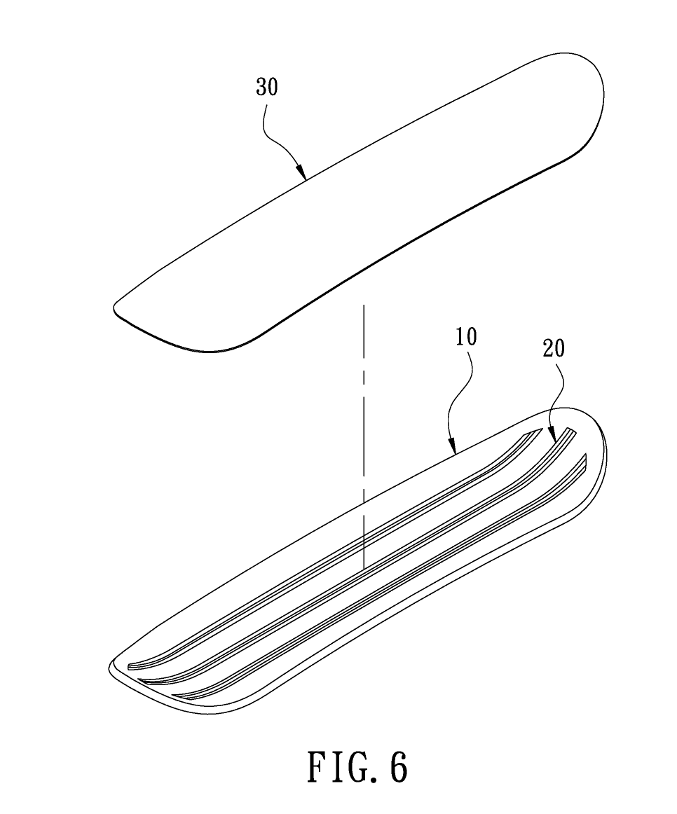

A fiber material covering step showed in FIG. 6 for covering the external periphery of the lining 10 with a fiber material 30 and the fiber material 30 being entirely covered the lining 10, the chosen fiber material 30 in this invention being a composite fiber, such as carbon fiber or glass fiber which has a light weight and a strong structure and is capable of being solidified by heat.

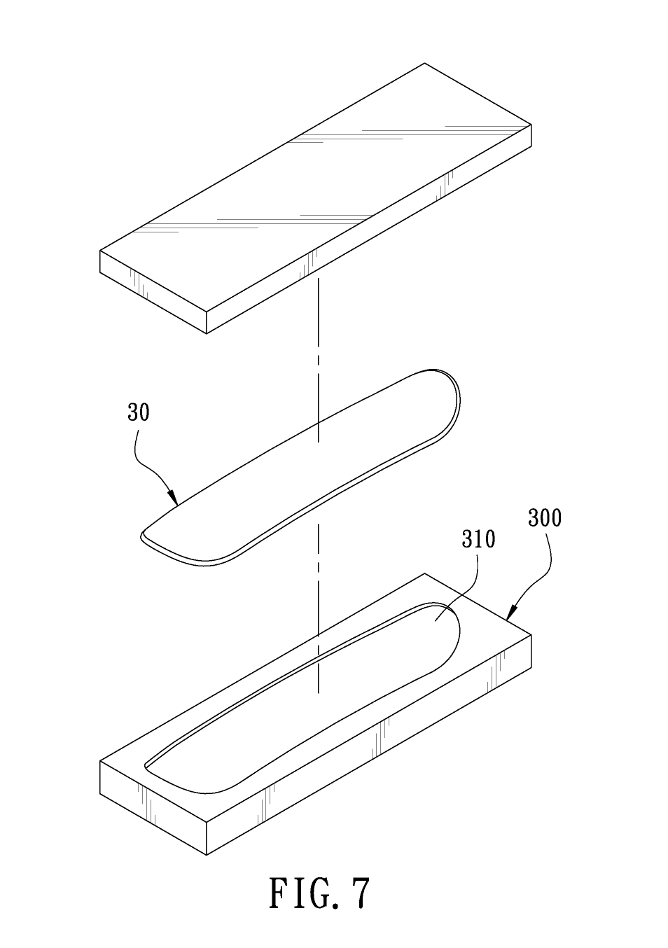

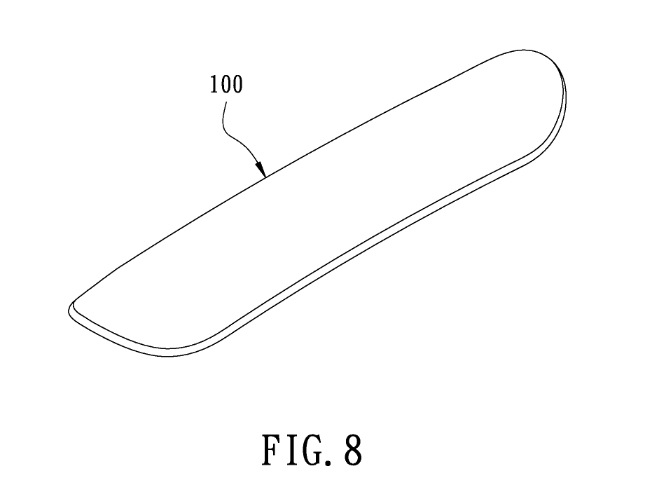

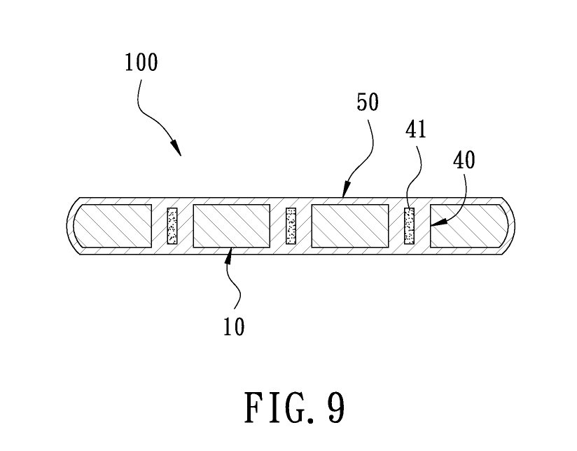

A board body forming step showed in FIG. 7 with FIG. 6 for preparing a second mold 300 which has a second chamber 310 therein, the second chamber 310 of the second mold 300 being a bit larger than the first chamber 210 of the first mold 200, the second chamber 310 providing a space for the lining 10 covered with the fiber material 30 and the inner wall of the second chamber 310 corresponding to an appearance and a size of the finished composite board, placing the lining 10 covered with the fiber material 30 into the second chamber 310 of the second mold 300, heating the lining 10 up, referring to the FIGS. 3 and 5, the foam material 21 in each of the fiber pipes 20 expanding and foaming by the heat to open the fiber pipes 20 and making the fiber pipes 20 push an inner side of fiber material 30 which covers the lining 10 from the long slots 11 of the lining 10 in order to melt and combine top and end of the fiber pipes 20 with the fiber material 30 covering the lining 10 by heat, referring to FIGS. 8 and 9 with FIG. 7, the foam material 21, the fiber pipes 20, and the fiber material 30 being solidified after cooling and the fiber pipes 20 being combined with the fiber material 30 as one structure, the fiber pipes 20 becoming reinforcement support structures and the fiber material 30 forming a predetermined appearance and size which corresponds to the inner wall of the second chamber 310.

FIGS. 8 and 9 are the perspective view and cross-sectional view showing a finished product of this invention. The finished composite board 100 disclosed therein includes:

A lining 10, referring to FIG. 3, made of at least one filler, acting as a board body, and containing a plurality of long slots 11 penetrating from top to bottom, in this invention, the lining 10 being PU foam, a size of the lining 10 being a little smaller than a size of the finished composite board 100, a plurality of the long slots 11 being formed in a parallel way through the major axis of the lining 10 and kept a predetermined distance with the periphery of the lining 10, the long slots 11 being capable of being set through the minor axis of the lining 10, or alternately being set through the major and minor axis.

A plurality of reinforcement ribs 40, referring to FIG. 4, the reinforcement rib acting as a pipe body that contains a foam material 21 being placed therein being located in the long slots 11 of the lining 10, the length of the reinforcement rib 40 corresponding to the major axial length of the long slots 11 and the width of the reinforcement rib 40 corresponding to the major axial width of the long slots 11, whereby the reinforcement rib 40 can be completely mounted and locked into the long slots 11 of the lining 10, in this invention, the chosen fiber material of the reinforcement ribs 40 being a composite fiber, such as carbon fiber or glass fiber which includes a light weight and a strong structure and is capable of being solidified by heat.

A covering layer 50 being set at the external periphery of the lining 10 and completely covering the lining 10, the covering layer corresponding to the appearance and size of the finished composite board 100 after covering the lining 10, the covering layer 50 and the reinforcement ribs 40 being melted as a whole structure by heat in order to make the reinforcement ribs 40 become a reinforcement supporting structure in the covering layer 50, in this invention, the chosen fiber material of the covering layer 50 being a composite fiber, such as carbon fiber or glass fiber, which includes a light weight and a strong structure and is capable of being shaped into solid by heat.

Referring to FIG. 3 to FIG. 6, the method of making the composite board is sequentially through the lining forming step, the fiber pipe rolling step, the fiber pipe mounting step, the fiber material covering step, and the board body forming step. The method is executed by filling the filler to form the lining 10 and placing the fiber pipes 20 into each of the long slots 11 of the lining 10, covering the fiber material 30 at the external periphery of the lining 10, heating the lining 10 covered with the fiber material 30 up, thereby melting and solidifying the fiber material 30 and the fiber pipes 20 into the finished composite board. Therefore, the method is simplified and time-shortened and increases economic effectiveness.

It is worth to be mentioned that the first chamber 210 of the first mold 200 is slightly smaller than the second chamber 310 of the second mold 300, whereby the second chamber 310 provides a space for the fiber material 30 to cover the lining 10 in order to form a predetermined size of the finished product.

Referring to FIGS. 8 and 9 with FIGS. 3 and 5, after the finished composite board is melted and solidified, the fiber pipe 20 in the long slots 11 of the lining 10 is combined with the fiber material 30 covered at the external periphery of the lining 10 into one fibrous structure, whereby the fiber pipes 20 become the supporting structure of the reinforcement ribs 40 in the fiber materials 30. Thus, the structure strength of the composite board is increased in order to form a finished product with a strong structure and keep the manufacturing method in simple.

It is worth to be mentioned that comparing to the method of the prior art including steps of machining, splicing, and lapping, the method of this invention is simplified, the operating time is effectively shortened and the economic effectiveness is increased. Further, the raw material of the filler for forming the lining 10 in this invention is easy to be obtained, thereby overcoming the problem that wood with high quality is hard to be obtained in the prior art. Besides, the fiber pipes 20 become a supporting structure of the reinforcement ribs 40 in the fiber material 30 in order to solve the problem of a weak structure of the finished product made of plastic in the prior art and create the finished product with a strong structure. The composite board of this invention made by the filler and the fiber material is much lighter than the metal or wood material used in prior art in order to keep the finished product with a light weight and overcome the problem of heaviness for metal material in the prior art.

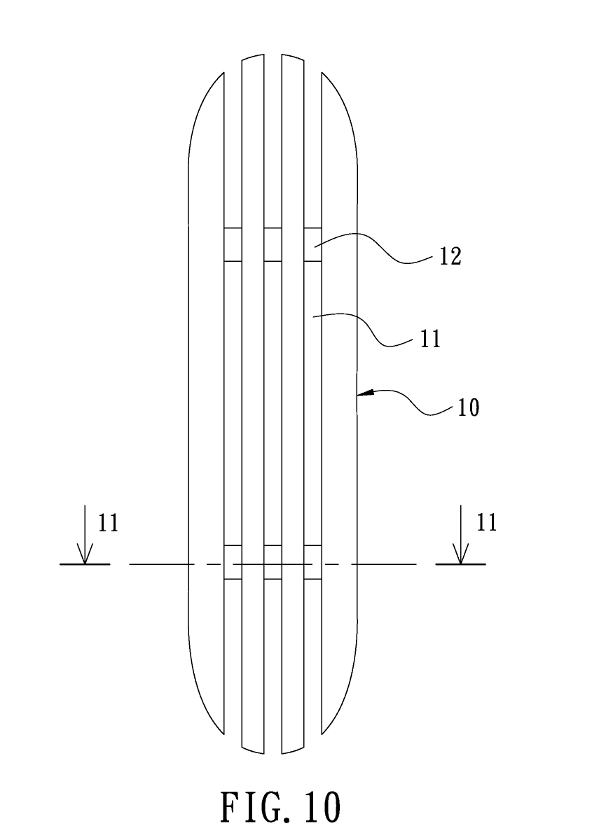

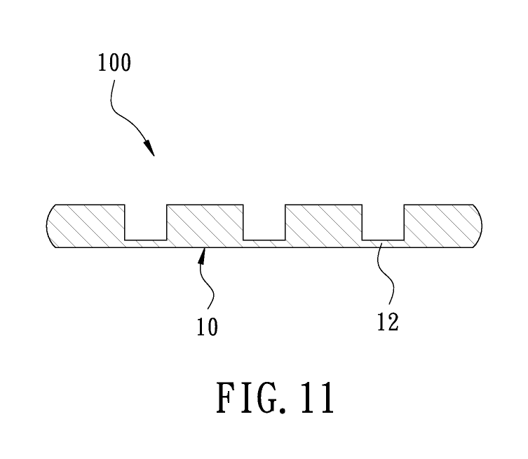

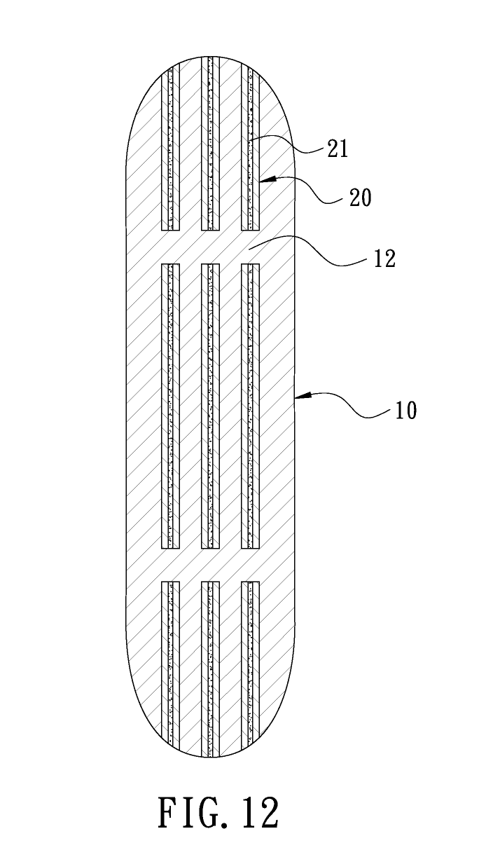

Referring to FIG. 10 to 12 showing other embodiment of this invention includes the top plan view of the lining, the cross-sectional view of other side of 11, and the cross-sectional view of the fiber pipe mounted in the lining. The differences with the aforementioned embodiment are that the long slots 11 extend and penetrate through the periphery of the lining 10, a plurality of linking ribs 12 are disposed in an inner wall of the long slots 11 of the lining 10, and the fiber pipes 20 respectively correspond to the long slots 11 in order to be placed into the long slots 11.

What is claimed is:

1. A method of making a composite board comprising:
a lining forming step for preparing a first mold which has a first chamber, filling at least one filler into said first chamber of said first mold, solidifying said filler to form a lining, and taking said lining out of said first mold, wherein said lining is formed by said first mold to provide a plurality of long slots penetrating from top to bottom;
a fiber pipe rolling step for respectively rolling a plurality of fiber materials into a plurality of fiber pipes and placing a foam material which is capable of foaming and expanding because of heat into each of said fiber pipes to make a size of said fiber pipes correspond to a size of said long slots respectively;
a fiber pipe mounting step for placing said fiber pipes into said long slots of said lining;
a fiber pipe covering step for covering an external periphery of said lining with a fiber material; and
a board body forming step for preparing a second mold which has a second chamber slightly larger than said first chamber of said first mold, putting said lining covered with said fiber materials into said second chamber of said second mold, heating up said lining to allow said fiber materials and said fiber pipes to be melted and combined at a high temperature and thereafter solidified by cooling.

2. The method of making the composite board as claimed in claim 1, wherein in said lining forming step, said first chamber of said first mold has a plurality of ribs convexly formed thereon, said lining being formed with said long slots by said ribs when said filler is filled into said first chamber of said first mold.

3. The method of making the composite board as claimed in claim 1, wherein in said fiber pipe rolling step, a pipe thickness of said fiber pipes is slightly smaller than a depth of said long slots.

4. The method of making the composite board as claimed in claim 1, wherein said filler in said lining forming step is PU foam, said fiber pipes in said fiber pipe rolling step being made by rolling a sheet of fiber materials, said fiber materials of said fiber pipes being carbon fiber or glass fiber, said fiber materials in said fiber material (fiber pipe) covering step being carbon fiber or glass fiber.

5. A composite board comprising:
a lining which acts as a board body containing a plurality of long slots penetrating from top to bottom;
a plurality of reinforcement ribs which acts as a pipe body containing a foam material being placed therein, said reinforcement ribs being disposed in said long slots of said lining; and
a covering layer covering an external periphery of said lining and combining with said reinforcement ribs.

6. The composite board as claimed in claim 5, wherein said lining has at least one linking rib arranged on inner walls of said long slots.

7. The composite board as claimed in claim 5, wherein a length of said reinforcement ribs corresponds to a major axial length of said long slots and a width of said reinforcement ribs corresponds to a major axial width of said long slots.

8. The composite board as claimed in claim 5, wherein said lining is completely covered by said covering layer.

9. The composite board as claimed in claim 5, wherein said covering layer and said reinforcement ribs are heated to become melted and combined as a whole.

10. The composite board as claimed in claim 5, wherein said long slots are parallel to each other.

11. The composite board as claimed in claim 5, wherein said lining is PU foam, said reinforcement ribs being carbon fiber or glass fiber, said foam material being a foam material which expands with heat, said covering layer being carbon fiber or glass fiber.
